(19) United States
(12) Patent Application Publication
(10) Pub. No.: US 2020/0008497 A1
(43) Pub. Date: Jan. 9, 2020

(54) WATERBORNE BONDING LAYER STRUCTURE BETWEEN SEA FISHING TROUSER LEGS AND SHOES OR BOOTS

(71) Applicant: PACIFIC EAGLE ENTERPRISE CO., LTD., Taichung City (TW)

(72) Inventor: James SHIH, Taichung City (TW)

(21) Appl. No.: 16/026,140

(22) Filed: Jul. 3, 2018

(51) Int. Cl. A41D 13/012; B32B 3/26; B32B 7/12; B32B 5/02; A41D 13/02; A43B 5/00; A41D 27/28

(52) U.S. Cl. CPC A41D 13/012; B32B 3/266; B32B 7/12; B32B 5/02; A41D 13/02; A43B 3/02; A41D 27/28; B32B 2307/7265; B32B 2437/02; A41D 2300/328; A43B 5/00

(57) ABSTRACT

The waterborne bonding layer structure between sea fishing trouser legs and shoes or boots includes a waterproof fabric layer, a bonding layer, and a fabric layer. The waterborne bonding layer bonds the waterproof fabric layer and the fabric layer together into one body. Besides, the bonding layer includes a plurality of foaming holes, each of which is smaller than the diameter of general liquid molecules and larger than that of general gas molecule, so that when an angler wears the fishing trousers, water droplets do not infiltrate into the inside of the fishing trousers while air can pass through the forming holes, thus reducing the occurrence of dew condensation and preventing uncomfortable wet and cold caused therefrom, achieving excellent waterproof and ventilating effects, and maintaining the wearing dryness for a long time, which greatly improves the comfort of the angler when wearing the sea fishing trousers of the invention.

### BACKGROUND

### Field of the Invention

The present invention relates to a bonding structure, and more particularly to a waterborne bonding layer structure between sea fishing trouser legs and shoes or boots.

### Related Prior Art

Fishing activities require the use of fishing rods, reels, fishing baits, buoys and other hardware equipments. During fishing activities, the angler has to wait for a long time outdoors, on river banks or wetlands, etc. Therefore, in addition to wearing hats for sun protection, the angler wears sea fishing pants that are different from ordinary trousers. This is especially true for sea anglers, so that the body is protected from being wet by the waves and causes physical discomfort.

Please refer to FIGS. 1A and 1B, a conventional sea fishing trousers 1 includes a leg layer 11, an upper layer 12, and a bonding layer 13 bonded between the leg layer 11 and the upper layer 12. The resin used for the bonding layer 13 is an oily resin. However, as far as the nature of the oily resin is concerned, its air permeability is not good, and the sea fishing trousers 1 made therefrom cannot produce a waterproof effect. Therefore, it is relatively difficult to use the oily rubber resin as the bonding layer 13 to discharge the water vapor outward, resulting in that the bonding layer 13 bonded between the leg layer 11 and the upper layer 12 may cause water vapor blocking problems. When the sea angler wears the sea fishing trousers 1 for a period of time, he/she may feel sultry and uncomfortable, and may even feel wet and sticky. The breathability of the sea fishing trousers 1 is still insufficient, so the scope of application is limited.

The present invention has arisen to mitigate and/or obviate the afore-described disadvantages.

### SUMMARY

One objective of the present invention is to provide a waterborne bonding layer structure between sea fishing trouser legs and shoes or boots, which has excellent performances of waterproof, moisture proof and air permeability.

To achieve the above objective, a waterborne bonding layer structure between sea fishing trouser legs and shoes or boots in accordance with the invention comprises:

a waterproof fabric layer including a waterproof fabric bonding surface;

a bonding layer made of waterborne resin and including: a first bonding portion that is sticky and is adhered to the waterproof fabric bonding surface, a second bonding portion that is sticky and connected to the first bonding portion, and a plurality of foaming holes penetrating the first and second bonding portions; and

a fabric layer including a fabric bonding surface attached to the second bonding portion to cover the foaming holes.

Preferably, the waterproof fabric layer includes a plurality of pores running through the waterproof fabric bonding surface, the fabric layer includes a plurality of micro-pores running through the fabric bonding surface, the bonding layer includes a plurality of bonding particles that constitute the first and second bonding portions, and the plurality of bonding particles are capable of being adhered to the pores and the micro-pores.

Preferably, each bonding particles has an adhesion area at its periphery, and the plurality of foaming holes are formed between adjacent adhesion areas, and each of the foaming holes has a diameter smaller than a diameter of general liquid molecules and larger than that of general gas molecules.

Preferably, the diameter of each of the foaming holes is 0.5-2 μm.

The waterborne bonding layer structure between sea fishing trouser legs and shoes or boots in accordance with the invention essentially consists of the waterproof fabric layer, the bonding layer, and the fabric layer. The waterborne bonding layer, after volatilization, bonds the waterproof fabric layer and the fabric layer together into one body. Besides, the bonding layer is volatilized to form the plurality of foaming holes. Since each of the foaming holes is smaller than the diameter of general liquid molecules and larger than that of general gas molecule, so that when the fisher or angler wears the invention, the water droplets do not infiltrate into the inside of the fishing trousers while the air can pass through the forming holes, thus reducing the occurrence of dew condensation and preventing uncomfortable wet and cold caused therefrom, achieving excellent waterproof and ventilating effects, and maintaining the wearing dryness for a long time, which greatly improves the comfort of the angler when wearing the sea fishing trousers of the invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1A is a perspective view of a conventional sea fishing trousers;

FIG. 1B is a magnified view of a part of FIG. 1A, showing the waterproof layer and the fabric layer;

FIG. 2 is an exploded view of the waterborne bonding layer structure between sea fishing trouser legs and shoes or boots in accordance with the invention, showing the waterproof fabric layer, the bonding layer and the fabric layer;

FIG. 3 is a cross sectional view of the waterborne bonding layer structure between sea fishing trouser legs and shoes or boots in accordance with the invention;

FIG. 4 is an exploded view of the waterborne bonding layer structure between sea fishing trouser legs and shoes or boots in accordance with the invention, showing that the bonding layer is made of a plurality of bonding particles; and

FIG. 5 is a cross sectional view of FIG. 4.

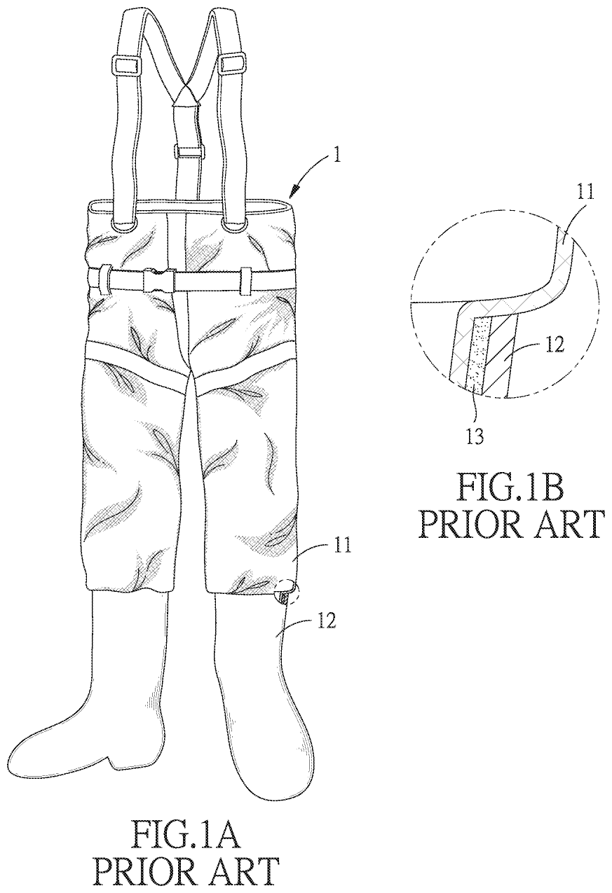

### DETAILED DESCRIPTION

The present invention will be clearer from the following description when viewed together with the accompanying drawings, which show, for purpose of illustrations only, the preferred embodiment in accordance with the present invention.

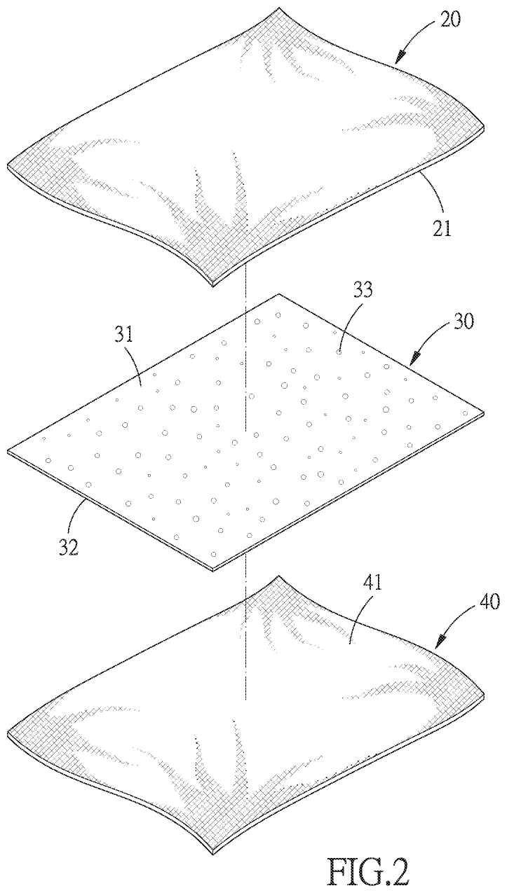

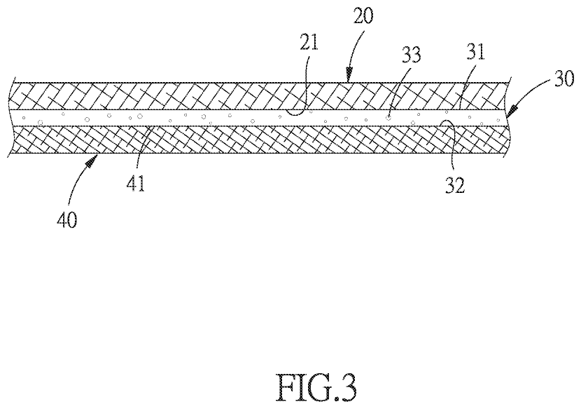

Referring to FIGS. 2-5, a waterborne bonding layer structure between sea fishing trouser legs and shoes or boots in accordance with the invention comprises: a waterproof fabric layer 20, a bonding layer 30, and a fabric layer 40.

The waterproof fabric layer 20 includes a waterproof fabric bonding surface 21 and is made of Nylon.

The bonding layer 30 is made of waterborne resin which has been volatilized for a period of time to form the bonding layer 30 which includes: a first bonding portion 31 that is sticky and can be adhered to the waterproof fabric bonding surface 21, a second bonding portion 32 that is sticky and connected to the first bonding portion 31, and a plurality of foaming holes 33 penetrating the first and second bonding portions 31, 32. The bonding layer 30 is environmentally friendly and does not contain toxic chemicals since it is made of water-borne resin.

The fabric layer 40 is attached to the wearer's skin and has a fabric bonding surface 41 that can be attached to the second bonding portion 32 to cover the foaming holes 33.

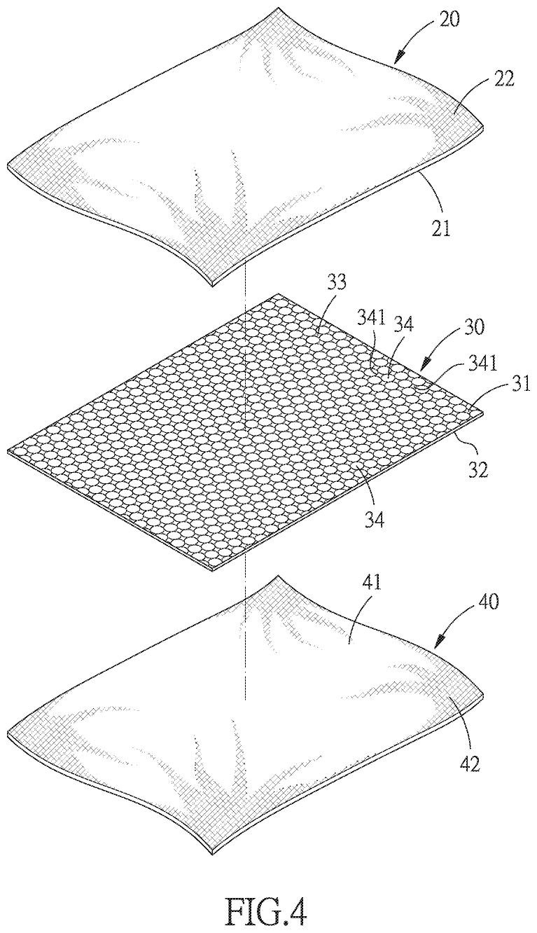

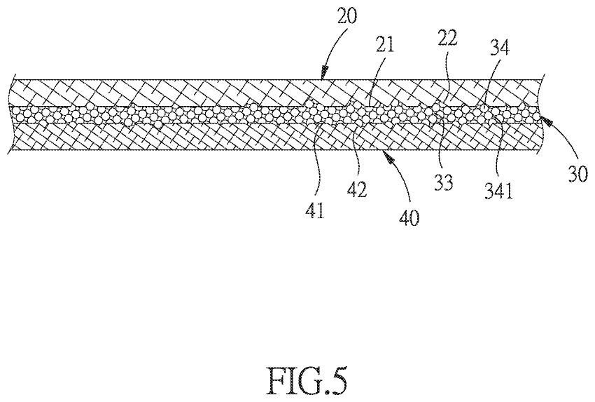

Referring to FIGS. 4 and 5, the waterproof fabric layer 20 includes a plurality of pores 22 running through the waterproof fabric bonding surface 21. The fabric layer 40 includes a plurality of micro-pores 42 running through the fabric bonding surface 41. The bonding layer 30 is volatilized for a while to form a plurality of bonding particles 34 in the form of ultrafine particles that constitute the first and second bonding portions 31, 32. The plurality of bonding particles 34 can be deeply adhered to the pores 22 and the micro-pores 42 to bond the waterproof fabric layer 20 and the fabric layer 40 together into one body. Each bonding particles 34 has an adhesion area 341 at its periphery, and the plurality of foaming holes 33 are formed between the adjacent adhesion areas 341. Each of the foaming holes 33 has a diameter of approximately 0.5-2 μm, which is smaller than the diameter of general liquid molecules and larger than that of general gas molecules. Since each of the foaming holes 33 is smaller than the diameter of general liquid molecules and larger than that of general gas molecule, the water droplets can be blocked by the foaming holes 33 when entering the waterproof fabric layer 20, however, the angler's sweat can be discharged through the foaming holes 33 to achieve the purpose of keeping dryness and improving comfort when wearing the fishing trousers for a long time.

What mentioned above are the structural configurations of the present invention and their connection relations, and the use of the present invention is described as follows:

The waterborne bonding layer structure between sea fishing trouser legs and shoes or boots in accordance with the invention essentially consists of the waterproof fabric layer 20, the bonding layer 30, and the fabric layer 40. Compared with the conventional technology of coating oily resin, which causes uncomfortable feeling of muggy heat and poor breathability, the waterborne bonding layer 30, after volatilization, bonds the waterproof fabric layer 20 and the fabric layer 40 together into one body. Besides, the bonding layer 30 is volatilized to form the plurality of foaming holes 33. Since each of the foaming holes 33 is smaller than the diameter of general liquid molecules and larger than that of general gas molecule, so that when the fisher or angler wears the invention, the water droplets do not infiltrate into the inside of the fishing trousers while the air can pass through the forming holes 33, thus reducing the occurrence of dew condensation and preventing uncomfortable wet and cold caused therefrom, achieving excellent waterproof and ventilating effects, and maintaining the wearing dryness for a long time, which greatly improves the comfort of the angler when wearing the sea fishing trousers of the invention.

While we have shown and described various embodiments in accordance with the present invention, it is clear to those skilled in the art that further embodiments may be made without departing from the scope of the present invention.

What is claimed is:

1. A waterborne bonding layer structure between sea fishing trouser legs and shoes or boots, comprising:
a waterproof fabric layer including a waterproof fabric bonding surface;
a bonding layer made of waterborne resin and including: a first bonding portion that is sticky and is adhered to the waterproof fabric bonding surface, a second bonding portion that is sticky and connected to the first bonding portion, and a plurality of foaming holes penetrating the first and second bonding portions; and
a fabric layer including a fabric bonding surface attached to the second bonding portion to cover the foaming holes.

2. The waterborne bonding layer structure between sea fishing trouser legs and shoes or boots as claimed in claim 1, wherein the waterproof fabric layer includes a plurality of pores running through the waterproof fabric bonding surface, the fabric layer includes a plurality of micro-pores running through the fabric bonding surface, the bonding layer includes a plurality of bonding particles that constitute the first and second bonding portions, and the plurality of bonding particles are capable of being adhered to the pores and the micro-pores.

3. The waterborne bonding layer structure between sea fishing trouser legs and shoes or boots as claimed in claim 2, wherein each bonding particles has an adhesion area at its periphery, and the plurality of foaming holes are formed between adjacent adhesion areas, and each of the foaming holes has a diameter smaller than a diameter of general liquid molecules and larger than that of general gas molecules.

4. The waterborne bonding layer structure between sea fishing trouser legs and shoes or boots as claimed in claim 1, wherein the diameter of each of the foaming holes is 0.5-2 μm.
